(19) United States
(12) Patent Application Publication
(10) Pub. No.: US 2016/0035029 A1
(43) Pub. Date: Feb. 4, 2016

(54) COMMODITIES RANKING AND BIDDING SYSTEM AND METHOD

(71) Applicant: Mohammad Fakhruddin Anwar, Houston, TX (US)

(72) Inventor: Mohammad Fakhruddin Anwar, Houston, TX (US)

(21) Appl. No.: 14/816,016

(22) Filed: Aug. 2, 2015

Related U.S. Application Data
(60) Provisional application No. 62/032,618, filed on Aug. 3, 2014.

(51) Int. Cl. G06Q 40/04

(52) U.S. Cl. CPC G06Q 40/04

(57) ABSTRACT

A system, method, and apparatus allowing commodity providers to identify and potentially acquire commodity consumers is described. Specially, the system, method, and apparatus comprises at least one communication component that receives commodity pricing offers from one or more commodity providers and user offers from one or more commodity users. The system, method, and apparatus further provides for a matching assessment component configured to assess each commodity provider's commodity pricing offer and the user's offer based at least partially on the commodity pricing offers and the user's offer to determine whether there is a match of offers. The system, method, and apparatus may also comprise a rank bidding component that allows commodity providers to bid for a higher rank in the offers presented to a user. The system, method, and apparatus may also comprise a facilitation component for facilitating a benefit to an entity based at least partially on the assessment.

### CROSS REFERENCES

This application claims the benefit of U.S. Provisional Application No. 62/032,618, filed on Aug. 3, 2014, which application is incorporated herein by reference.

### FIELD OF THE INVENTION

A preferred embodiment of a version of the invention refers to a method and apparatus for identification and acquisition of consumers that match an offer for commodities with a commodity provider.

### BACKGROUND

Generally, pricing of various commodities is varied from seller to seller. One example is gas and electricity. A typical gas and electricity consumer searches online to look for service providers that serve their area. The first input is typically the service location (Zip Code). Once entered, the commodity provider displays the available products and plans for that service location. The consumer then may choose one of the available products and plans. There are also brokers that list multiple commodity provider products and plans that serve a geographic location in a single comparative listing. The consumer generally has the option of choosing any one of the available products and plans at the listing price. The pricing is dictated by the commodity providers and only allows the consumer to select the best available product and plan. There is no system that allows commodity consumers to dictate the price, where commodity providers are allowed only to accept or reject the commodity consumer offer.

Additionally, commodity providers often rely on their own website or a brokerage website for acquiring new consumers. Currently brokers will list products and plans on behalf of commodity providers in some orderly fashion that may be influenced by a multitude of factors including commission agreements between the brokerage and the commodity providers. Thus, commodity consumers may not be offered the lowest price plan that may be available from the commodity providers.

Therefore, there is a need in the art for a method and system allowing commodity users to place offers for purchasing commodities. The system will compare these offers to acceptable offer ranges provided by commodity providers. In this way, the system will allow the user to dictate the price in which he is willing to pay for commodities, and will allow commodity providers to accept or reject each commodity provider's offer.

### SUMMARY

A preferred embodiment of the invention is a method and system allowing commodity users to place offers for purchasing commodities. The system compares the user offers to acceptable offer ranges provider by commodity providers. A preferred embodiment of the invention is a method and system comprising at least one communication component configured to receive commodity pricing offers from one or more commodity providers and user offers from one or more commodity users. The system further provides for a matching assessment component configured to assess each commodity provider's commodity pricing offer and the user's offer based at least partially on the commodity pricing offers and the user's offer to determine whether there is a match of offers. Additionally, a preferred embodiment comprises a facilitation component configured to facilitate a benefit to an entity based at least partially on the assessment. The entity receiving the benefit based at least partially on the assessment may be a commodity service provider.

A preferred embodiment of a version of the invention comprises a rank bidding components configured to allow commodity providers to bid tokens such that each matching commodity provider's offer will be presented in a specific order. Additionally, a preferred embodiment of a version of the invention comprises a lead bidding component configured to allow commodity providers to bid tokens to acquire a certain commodity user lead.

### BRIEF DESCRIPTION OF THE FIGURES

The objects, features and advantages of the present invention will be more readily appreciated upon reference to the following disclosure when considered in conjunction with the accompanying drawings, in which:

FIG. 1A is a schematic showing a preferred implementation consistent with the present Invention.

FIG. 1B is a schematic showing the components of some of the servers that comprise a preferred implementation of the present Invention.

FIG. 2A is a schematic showing the operation of a preferred implementation of the present Invention.

FIG. 2B is a schematic showing the operation of a Background Job Manager in a preferred implementation of the present Invention.

FIG. 3 is a schematic of a preferred implementation of a system for broadcasting bidding information to the commodity providers.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with or in the context of other particular aspects of the embodiments of the invention, and in the invention generally.

The term “comprises” and grammatical equivalents thereof are used herein to mean that other components, steps, etc. are optionally present. For example, an article “comprising” components A, B, and C can contain only components A, B, and C, or can contain not only components A, B, and C, but also one or more other components.

Where reference is made herein to a method comprising two ore more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

In the following detailed description, reference is made to the accompanying drawings that form a part hereof, and in which is shown by way of illustration specific embodiments in which the subject matter can be practiced. These embodiments are described in sufficient detail to enable those skilled in the art to practice them, and it is to be understood that other embodiments can be utilized and that structural, logical, and electrical changes can be made without departing from the scope of the inventive subject matter. Such embodiments of the inventive subject matter can be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense.

In one implementation, the system comprises a network, which may include multiple clients connected to multiple servers via a network. Network may include one or more networks of any kind, including, but not limited to, a local area network (LAN), a wide area network (WAN), a telephone network, such as the Public Switched Telephone Network (PTSN), an intranet, the Internet, a memory device, another type of network, or a combination of networks.

Clients may include devices of users that access servers. A client may include, for instance, a personal computer, a wireless telephone, a personal digital assistant (PDA), a laptop, a smart phone, a tablet computer, or another type of computation or communication device. Servers may include devices that access, fetch, aggregate, process, search, provide, and/or maintain documents. Each server may, in some implementations, be implemented as multiple computing devices, which potentially may be geographically distributed.

The search servers may include one or more computing devices designed to implement a search engine, such as a documents/records search engine, general webpage search engine, etc. A search server may, for example, include one or more web servers to receive search queries and/or inputs from clients, search one or more databases in response to the search queries and/or inputs, and provide documents and/or information, relevant to the search queries and/or inputs, to clients. In some implementations, a server may include a web search server that may provide webpages to clients, where a provided webpage may include a reference to a web server, such as one of web servers, at which the desired information is located and other information and/or links. The references, to the web server at which the desired information is located, may be included in a frame and/or text box, or as a link to the desired information/document.

Data indexing server may include one ore more computing devices designed to index documents available through network. Data indexing server may access other servers, such as web servers that host content, to index the content. In some implementations, data indexing server may index documents/records stored by other servers, such as web servers and, connected to network. Data indexing server may, for example, store and index content, information, and documents relating to a user's offer price, zip code, and commodity provider acceptance ranges.

Web servers may include web servers that provide webpages to clients. The webpages may be, for example, HTML-based webpages. A web server may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

The term “component” or “mechanism” may be used herein to describe one or more servers and/or processors. Thus a component configured to perform a certain task may be one server and/or processor, or more than one server and/or processor working together, programmed to perform a specific task. Similarly, a mechanism configured to perform a certain task may be one server and/or processor, or more than one server and/or processor working together, programmed to perform a specific tasks. While servers may be shown or described as separate entities, it may be possible for one or more servers to perform one or more of the functions of another one or more of servers. For example, it may be possible that two or more of servers are implemented as a single server. It may also be possible for one of servers to be implemented as multiple, possibly distributed, computing devices.

A computing device as set forth herein may be used with the techniques described here. The computer device may correspond to, for example, a client and/or a server. Computing device is intended to represent various forms of digital computers, such as laptops, desktops, workstations, personal digital assistants, servers, blade servers, mainframes, and other appropriate computers. Mobile computing device is intended to represent various forms of mobile devices, such as personal digital assistants, cellular telephones, smart phones, tablet computers, laptops and other similar computing devices. Their connections and relationships, and their functions, are meant to be examples only, and are not meant to limit implementations described herein.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to commodity provider acceptance ranges for specific commodities and user offer prices, location, and other terms Said information is accessible through a server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components. Any form of medium of digital communication can interconnect the components of the system.

Generally, a preferred embodiment of the invention is a system comprising at least one communication component configured to receive commodity pricing offers from one or more commodity providers and user offers from one or more commodity users. The system further provides for a matching assessment component configured to assess each commodity provider's commodity pricing offer and the user's offer based at least partially on the commodity pricing offers and the user's offer to determine whether there is a match of offers. Additionally, a preferred embodiment comprises a facilitation component configured to facilitate a benefit to an entity based at least partially on the assessment. The entity receiving the benefit based at least partially on the assessment may be a commodity service provider.

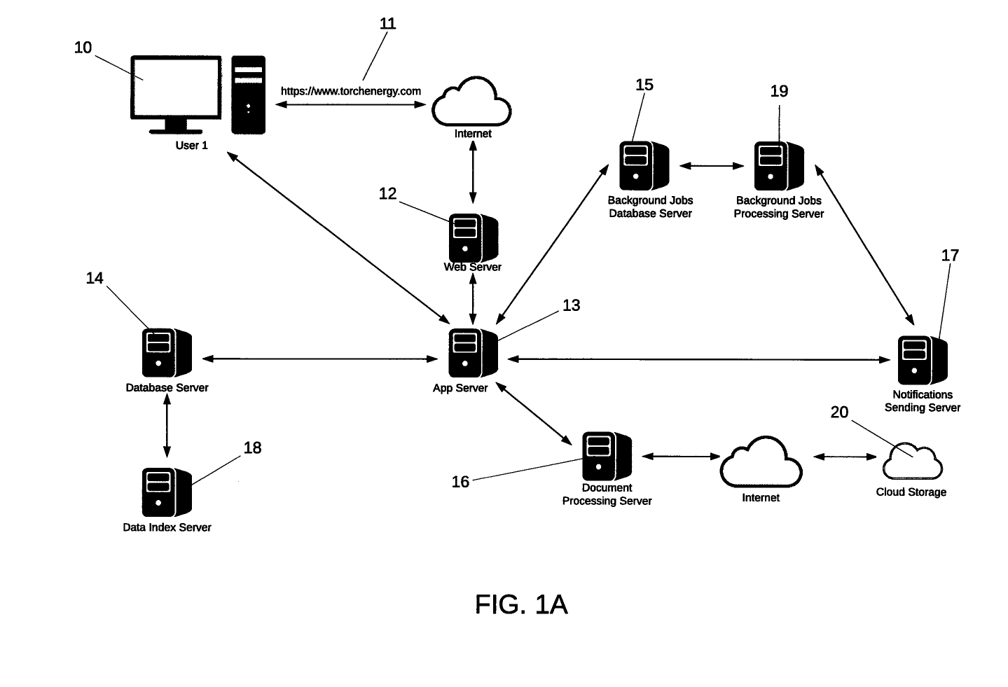

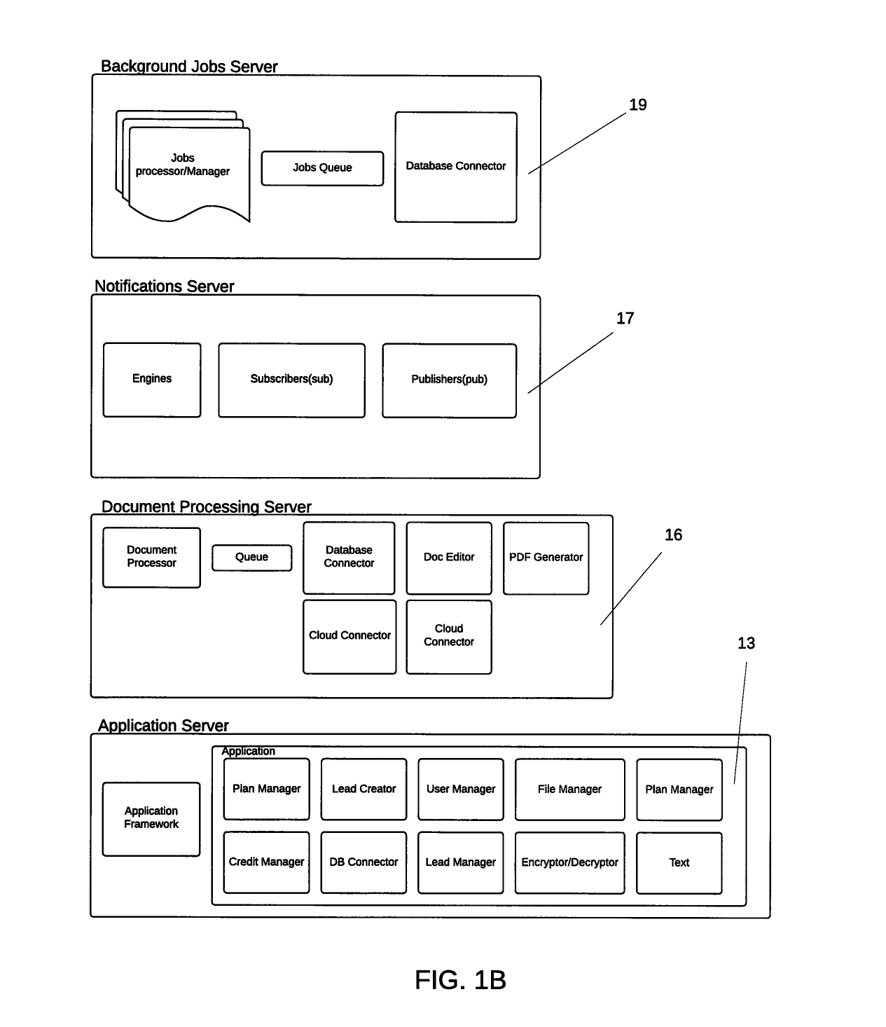

More specifically, as set forth in the FIG. 1A, the overall architecture of the system may be based on various servers and databases. However, it is understood that said servers and databases may be combined or modified to one or more servers and/or databases. Illustrated in FIG. 1A and FIG. 1B, a preferred implementation comprises a user 10 navigating via the Internet to a system webpage 11 at which point a web server 12 will be in communication with an application server 13. The application 13 server may further be in communication with a database server 14, background jobs database server 15, a document processing server 16, and a notifications sending server 17. Preferably, the database server 14 is in communication with a data index server 18. Preferably, the background jobs database server 15 is in communication with a background jobs processing server 19, which is in communication with the notifications sending server 17. Preferably, the document processing server 16 may store information in the cloud 20 via the Internet.

The software of the current invention provides a method and apparatus for identification and acquisition of consumers that match an offer for commodities with a commodity provider. In a preferred implementation, the application provides a method and system for identification and acquisition of energy consumers that match an offer price for energy services from a retail energy provider.

In yet other embodiments of the invention, the application provides a method and system for identification and acquisition of various commodity consumers, including, but not limited to: diamonds and other precious stones; gold, silver, platinum and other precious metals; live animals; meat and edible meat; fish; dairy products; trees; edible vegetables; coffee, tea, and spices; oil; oil seeds; grains; fruit; sugars; cocoa; beverages, spirits, vinegar; tobacco; salt, sulphur, earth, stone, plaster, lime and cement; mineral fuels, distillation products; organic and inorganic chemicals; tanning, dyeing extracts, tannins, pigments; Essential oils, perfumes, cosmetics, toiletries; Soaps, lubricants, waxes, candles, modelling pastes; Plastics and articles thereof; Rubber and articles thereof; Raw hides and skins and leather; Wood and articles of wood, wood charcoal; Cork and articles of cork; Paper & paperboard, articles of pulp, paper and board; Printed books, newspapers, pictures etc; silk; Wool, animal hair, horsehair yarn and fabric thereof; cotton; Wadding, felt, nonwovens, yarns, twine, cordage, etc; Special woven or tufted fabric, lace, tapestry etc; Iron and steel; Copper and articles thereof; Nickel and articles thereof; Aluminium and articles thereof; Lead and articles thereof; Zinc and articles thereof; Tin and articles thereof.

A preferred implementation of a version of the invention comprises two primary methods for providing a quote for commodities to an end user. These are referred to herein as the plan ranking method and the consumer leads bidding method.

The plan ranking method requires that commodity providers load plans into a system in order for consumer offers to be searched against, and matched to, those commodity providers' plans. Commodity providers may navigate to a system webpage to load plans. In a preferred embodiment, in order to filter each commodity provider's information and plans, there are at least regional and bidding qualifiers. Regional qualifiers may comprise fields relating to at least one of the following: Country, State/Providence/District, City/Zip Code, and the Transmission and Distribution Utility (TDU) for which the product is available.

Bidding qualifiers may comprise fields relating to at least one of the following: (1) pricing range that the commodity provider is willing to sell its product (X cents to Y cents); (2) Maximum Tokens to be used per click (Z tokens); (3) Daily Token Allowance: the maximum number of tokens to be utilized per day (A credits; A>Z); (4) Campaign Token Allowance: the maximum number of tokens to be utilized for the entire bidding campaign which typically will have a date range (B credits; B>A). Additional text fields may comprise campaign name, plan name, campaign start date, campaign end date, plan expiration date, term length, base charge, termination fee, description, documents, Electricity Fact Labels (EFLs), and others.

In a preferred implementation, a commodity provider will be able to purchase tokens for using the system. A commodity provider may log into the system and purchases tokens. These tokens allow a commodity provider to receive leads and make bids on leads, as further described herein.

Us the system and method set forth herein, to find a match a user must enter a date of the consumer offer that is within the date range of at least one commodity provider's campaign. Additionally, the matching commodity providers must have enough tokens available in each of their respective accounts to be able to make a maximum bid. Thus, the commodity provider maximum token allowance for the campaign must not have been reached and the commodity provider maximum daily token allowance must not have been reached for that campaign.

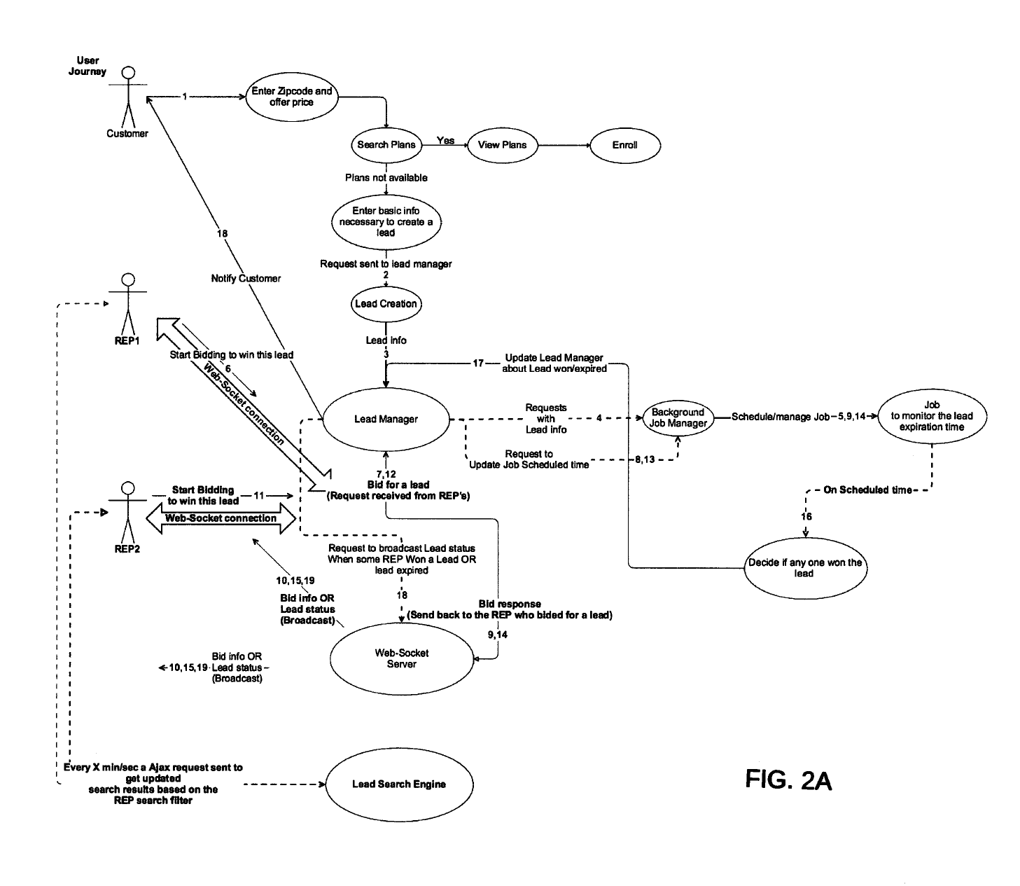

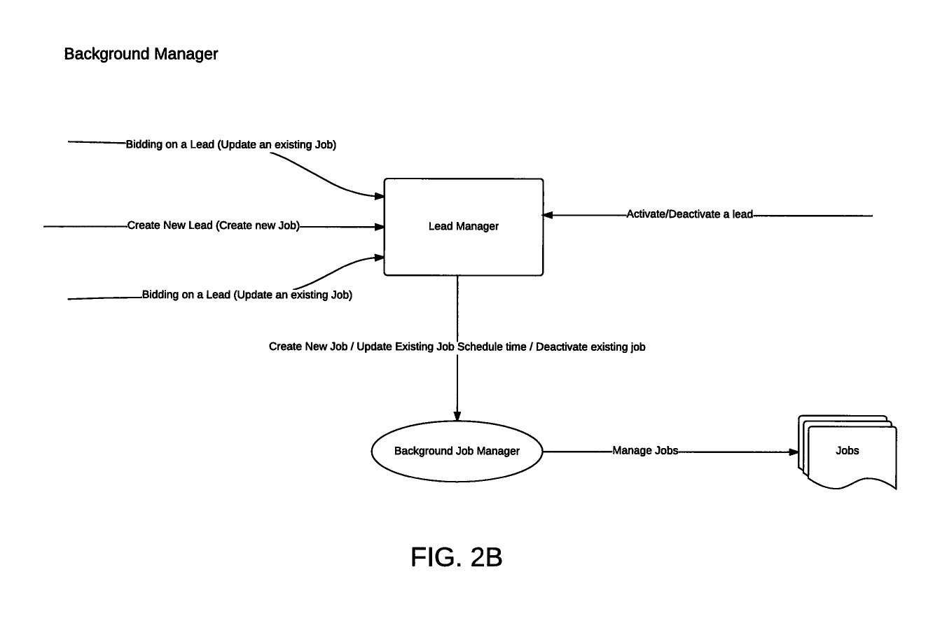

Generally, as illustrated in FIG. 2A, a user navigates to a system webpage and enters his zip code and preferred offer price. This information may be typed into a text field. Once the information is entered and submitted a system processor searches at least one database for all the available prices and zip codes that are entered by the commodity providers.

In one embodiment, if there is a match, a facilitation component is configured to present the user with a link to at least one matching commodity provider such that said user may purchase the commodity at the matching price and enroll in the plan. In one embodiment the facilitation component is an application server in communication with at least one database. Alternatively, the user may be taken to a user interface in which he will be presented with multiple matching plans from matching commodity providers. A user will be able to choose a plan to view, and will then be able to enroll in the plan. Once a user chooses the plan he would like to enroll in, he may begin the enrollment process. A user may be asked to provide personal information. In one embodiment, this information is gathered through text fields. These text fields may comprise the following: name, email address, phone number, birthdate, service type desired, desired contract period, city, state, zip code, communication preference and preferred time of contact, and others. Preferably, a user will be able to confirm the entered information before submission.

A preferred embodiment of a version of the invention comprises a rank bidding component configured to allow commodity providers to bid tokens such that each matching commodity provider's offer will be presented to the user in an order based on the number of tokens each matching commodity provider bids. Preferably, commodity providers may purchase tokens through the system webpage. In coordination with the rank bidding component, a presenter component is configured to present the matching commodity providers in a specific rank. Thus, the matching offer of the commodity provider having the highest bid will be presented first. The matching offer of the commodity provider having the second highest bid will be presented second. Any other commodity providers' offers may be presented to the user in the order of highest bidder to lowest bidder.

In one implementation, if multiple commodity providers (G) bid the same number of maximum tokens per bid, then a random commodity provider is selected for the rank (N) that the commodity providers would have qualified. The commodity providers that are not randomly selected for the Nth rank will be assigned the rank of N+1, N+2 . . . N+G . . . until all of “G” commodity providers have been ranked. Preferably, the tokens that are charged to any given commodity provider never exceed the maximum tokens per click. Furthermore, the number of final tokens charged to each commodity provider in the ranking is dependent on the total number of qualifying plans. For example, if a commodity provider bids a maximum of 10 tokens but there are only a total of 4 qualifying plans offered by commodity providers, then it will get charged 4 tokens only. The commodity provider is only charged the appropriate number of tokens when a consumer clicks on one of the qualifying plans.

For example, in the system for identification and acquisition of energy consumers, A Energy Co. offers the highest number of tokens for users falling within its corresponding plan. B Energy Co. offers less tokens for users falling within its corresponding plan. Thus A Energy Co.'s plan will be listed first because A Energy Co. bid the most tokens. B Energy Co. will be listed in the second position (rank). If A Energy Co. and B Energy Co. are the only two companies listed, A Energy may be charged two tokens if a user clicks on his plan since it is the first of two companies listed. If B Energy Co. is listed second, but the user decided to click on its plan, instead of A Energy Co., B Energy Co. would be charged one token since it is the second of two companies listed. Other implementations of the invention may comprise different charging methods.

It is possible that a user's offer will not be matched with a commodity provider plan. In such a case, in a preferred embodiment, the user is notified that no commodity provider plans match his offer, but that the offer will be provided to commodity providers for review. As illustrated in FIG. 2A, in a preferred implementation a user is asked to provide certain billing information. This billing information may include at least one of the following: whether he will accept auto-bill pay, paperless billing, term length of contract, and service start date. The user's original offer and additional information comprise a lead.

As illustrated in FIG. 2A and FIG. 2B, the lead is then added to a lead management component. This lead management component is preferably a Consumer Lead Bidding database. In a preferred implementation, commodity providers have access to all of these accumulated consumer leads. In one embodiment, commodity providers have the option to buy the lead for a pre-set number of tokens. In this embodiment, the system may comprise a sales component configured to allow each commodity provider to buy the lead for a pre-set number of tokens.

If the commodity providers choose not to buy the lead, they have the option to bid with a certain amount of tokens. In one embodiment, the commodity providers have twenty-four (24) hours to “bid” on the lead. In other embodiments, the commodity providers may have more or less time.

In a preferred embodiment, once a bid for a lead is received the lead manager sends a request to update the job schedule time. The background job manager managers the lead expiration time. Once the server has accepted the bid and the lead expiration time has been updated, the system will notify other commodity providers of the bid information or lead status.

For example, as illustrated in FIG. 2A, in one embodiment, retail energy provider 2 (REP2) may start bidding to try and win the lead from the first retail energy provider (REP1). In so doing, REP 2 places its bid request which is communicated to the lead manager. The second bid is communicated to the background job manager and the lead expiration time may be updated. The bidding process may continue for a predetermined set of time. Once the lead expiration time is reached the system will update the lead manager about whether a commodity provider won the lead, and/or whether the lead expired. The lead manager will then notify the user of the lead results. If a commodity provider wins the lead, the user will be sent a link for enrolling in the winning commodity providers plan. The lead manager also broadcasts the lead status to a server which then communicates the bid info and/or lead status to the commodity provider.

However, if a third retail energy provider (REPC)(not pictured) decides it wants the lead within Z time after REPA and REPB have bid, this is an “Accept Now” action for a preset number of tokens Y. Immediately upon accepting the preset number of tokens Y, REPC's Product offer is sent to the customer for sign up.

In a preferred embodiment, as set forth above, every time a bid is placed by another commodity provider the time is extended for Z more hours not exceeding longer than 24 hours since the consumer gets added to the Consumer Lead Bidding database. In other embodiments the time may be extended for Z more hours exceeding 24 hours.

As illustrated in FIG. 2A and FIG. 2B, the lead manager receives new leads (new job is created). The lead manager is in communication with a background job manager which manages the separate jobs (leads). After the job creation, the lead manager accepts bids on leads and communicates those leads to the background manager. The lead manager may also communicate to the background manager that a job/lead schedule and/or expiration time should be updated, whether to activate or deactivate a job/lead, or other similar actions.

In a preferred implementation, the system comprises WebSocket connections between the commodity providers and the system. However, it is understood that other forms of communication may also be used herein.

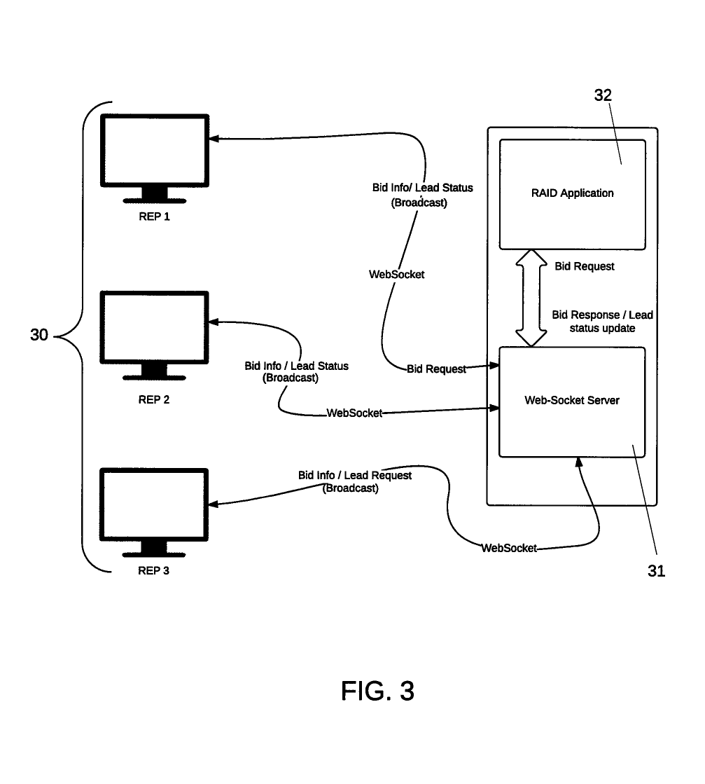

As illustrated in FIG. 3, a preferred implementation comprises a system for broadcasting bidding information to the various commodity providers 30. In one implementation, a commodity provider makes a bid request via a websocket 31, which is in turn communicated to a RAID application 32. The application then communicates current bid information and lead status via a websocket 31 to the commodity providers 30. This process takes place until a commodity provider 30 wins the lead, or the lead time expires. Other implementations of the invention may comprise different communication techniques.

Using the system and method set forth herein, to bid on a lead a commodity provider must have enough tokens available in the account to be able to make a bid. A commodity provider may log in to the system and purchase tokens for bidding. In one implementation all consumer leads become available for a total time period of 24 hours. In yet another implementation, if a second bid is placed before the expiration of a 2-hour time limit, a new 2-hour limit begins again right after the subsequent bid is placed. If bids are placed by multiple commodity providers during this 24 hour timeframe, the commodity provider that has the last bid at the time of 24 hour expiration will be the rightful owner of the lead. In a preferred implementation, the commodity provider gets charged the number of tokens when the auction has expired and the lead has been assigned to them.

In a preferred implementation, as illustrated in FIG. 1A, a web page 11 is served from a web server 12 to a client browser 10. The web page 11 is served to collect commodity user offer data and commodity provider offer data entered via the served web page 11. Commodity user offer data is collected, wherein the user offer data is entered via the served web page 11. Commodity provider offer data is collected, wherein the commodity provider offer data is entered via the served web page 11. A first mechanism is provided in the served web page 11 that activates when the first mechanism detects a commodity user offer that falls within a range of a retailer commodity provider's offer. If activated, the first mechanism submits the retailer commodity provider's offer to the user. A second mechanism is provided in the served web page 11 that activates when the commodity user offer data does not fall within a range of at least one commodity provider's offer data. If activated, the second mechanism queries the commodity user 10 for additional billing information to create a lead, said lead being available to commodity providers. The first and second mechanisms contain code necessary to detect an offer match or non-match.

In yet another embodiment, if the first mechanism detects a match between a user's offer and at least one commodity provider's offer, the first mechanism will present the user with a link to at least one matching commodity provider. This link will allow the user to purchase the commodity at the matching price.

In yet another embodiment, the method further comprises providing a rank bidding component configured to allow commodity providers to bid tokens such that each matching commodity provider's offer will be presented to the user in an order based on the number of tokens each matching commodity provider bids. Using this method, the matching offer of the commodity provider having the highest bid will be presented first. The matching offer of the commodity provider having the second highest bid will be presented second. Any other commodity providers' offers may be presented to the user in the order of highest bidder to lowest bidder.

If more than one commodity provider bids the same number of maximum tokens per bid a random commodity provider is selected for the first rank (N). The commodity providers that are not randomly selected for the Nth rank will be assigned the rank of N+1, N+2, . . . N+G, based on the number of tokens bid, until all of the commodity providers have been ranked.

A preferred embodiment of the method further comprises providing a lead management component for handling various leads. Each commodity provider has access to the leads of the lead management component and may buy the lead for a pre-set number of tokens.

Illustrated in FIG. 2A, a preferred embodiment of the method further comprises providing a lead bidding component configured to allow commodity providers to bid tokens to acquire a lead. After a pre-set amount of time, the commodity provider having bid the highest number of tokens will win the lead. The plan of the highest bidding retailer commodity provider will be sent to the user for enrollment in the plan.

An embodiment of the invention comprises a computer-readable storage device having computer-executable instructions stored thereto. When these instructions are executed by a computer, the program serves a web page from a web server to a client browser to collect a commodity user's offer data and at least one commodity provider's offer data entered via the served web page. The program provides a first mechanism in the served web page that activates when the mechanism detects commodity user offer data that falls within a range of at least one commodity provider's data. The first mechanism contains code necessary to detect an offer match. The program provides a second mechanism in the served web page that activates when the commodity user offer data does not fall within a range of a retailer commodity provider's offer. The second mechanism contains code necessary to detect when an offer does not match.

If the computer program detects a match, it serves a web page from a web server to the client browser that allows the commodity user to purchase the commodity.

In a preferred embodiment, the computer program further comprises a rank bidding component in the served web page. The rank bidding component is configured to allow commodity providers to bid tokens such the each matching commodity provider's offer will be presented to the user in an order based on the number of tokens each matching commodity provider bids.

In a preferred embodiment, the computer program further comprises a charging component configured to charge tokens to at least one of the commodity providers that is displayed to a user. The number of tokens charged to at least one commodity provider in the ranking is dependent on the total number of qualifying plans. The maximum number of final tokens charged to each commodity provider in the ranking is equal or less than the number of matching plans offered to the user.

If the computer program product does not detect a match, it serves a web page to the client browser that allows the commodity user to enter additional billing information. This billing information and the commodity user's offer comprise a lead. This lead is provided to a database accessible to commodity providers. In a preferred embodiment, each commodity provider may buy the lead for a pre-set number of tokens. Alternatively, as set forth herein, commodity providers may be able to bid tokens to acquire the lead.

Embodiments of the current invention comprise various interfaces, including, but not limited to those having the following functionality: 1) allowing for the commodity providers to input their ranking strategy; 2) allowing for the consumers to visualize matched products and plans 3) allowing for commodity providers to bid on non-matched consumers and 4) providing a dashboard to visualize performance metrics for each commodity provider. This methodology and the application allows for multiple commodity providers to bid for a consumer.

It will be readily understood to those skilled in the art that various other changes in the details, material, and arrangements of the parts and method stages which have been described and illustrated in order to explain the nature of this inventive subject matter can be made without departing from the principles and scope of the inventive subject matter.

What is claimed is:

1) A system, comprising:
a) at least one communication component configured to receive:
commodity pricing offers from one or more commodity providers;
user offers from one or more commodity users;
b) a matching assessment component configured to assess each commodity provider's commodity pricing offer and the user's offer based at least partially on the commodity pricing offers and the user's offer to determine whether there is a match of offers; and
c) a facilitation component configured to facilitate a benefit to an entity based at least partially on the assessment.

2) The system of claim 1, wherein said facilitation component is configured such that if the matching assessment component detects a match between a user's offer and at least one commodity provider's offer, said facilitation component will present the user with a link to at least one matching commodity provider such that said user may purchase the commodity at the matching price.

3) The system of claim 1, further comprising:
a) a rank bidding component configured to allow commodity providers to bid tokens such the each matching commodity provider's offer will be presented to the user in an order based on the number of tokens each matching commodity provider bids,
b) a matching offer of the commodity provider having the highest bid will be presented first with the first rank,
c) a matching offer of the commodity provider having the second highest bid will be presented second with the second rank,
d) any other commodity providers' offers may be presented to the user in the rank of highest bidder to lowest bidder, and
e) a presenter component configured to present the matching commodity providers in a specific rank.

4) The method of claim 3, further comprising:
a) if more than one commodity provider bids the same number of maximum tokens per bid, then a random commodity provider is selected for the first rank (N);
b) wherein the commodity providers that are not randomly selected for the Nth rank will be assigned the rank of N+1, N+2, . . . N+G, based on the number of tokens bid, until all of the commodity providers have been ranked.

5) The method of claim 3, further comprising:
a) a charging component that charges a number of tokens to each commodity provider in the ranking is dependent on the total number of qualifying plans;
b) wherein, the maximum number of tokens charged to each commodity provider in the ranking is equal or less than the number of matching plans offered to the user.

6) The system of claim 1, further comprising:
a) the matching assessment component configured such that if the matching assessment component does not detect a match between a user's offer and at least one commodity provider's offer, a lead is generated, said lead comprising the user's unmatched offer and additional billing information;
b) a lead management component configured to allow commodity providers to bid on a lead;
c) said lead being added to the lead management component, wherein all commodity providers of the system have access to a group of accumulated leads.

7) The system of claim 6, further comprising, a sales component configured to allow each commodity provider to buy the lead for a pre-set number of tokens.

8) The system of claim 7, further comprising:
a) the sales component configured such that if no commodity providers buy the lead, the commodity providers have the option to bid a certain amount of tokens to acquire the lead;
b) wherein, after a preset amount of time, the commodity provider having bid the highest number of tokens will win the lead; and
c) a presenter component configured to present a plan of the highest bidding commodity provider to the user for enrollment in the plan.

9) A method for matching a commodity provider and consumer, comprising:
a) serving a web page from a web server to a client browser, the web page served to collect commodity user offer data and commodity provider offer data entered via the served web page;
b) collecting commodity user offer data, wherein the user offer data is entered via the served web page;
c) collecting commodity provider offer data, wherein the commodity provider offer data is entered via the served web page;
d) providing a first mechanism in the served web page that activates when the first mechanism detects a commodity user offer that falls within a range of a retailer commodity provider's offer;
e) providing a second mechanism in the served web page that activates when the commodity user offer data does not fall within a range of at least one commodity provider's offer data;
f) wherein the first and second mechanisms contain code necessary to detect an offer match or non-match,
g) wherein the first mechanism submits the retailer commodity provider's offer to the user;
h) wherein the second mechanism queries the commodity user for additional billing information to create a lead, said lead being available to commodity providers.

10) The method of claim 9, further comprising, if the first mechanism detects a match between a user's offer and at least one commodity provider's offer, said first mechanism will present the user with a link to at least one matching commodity provider such that said user may purchase the commodity at the matching price.

11) The method of claim 9, further comprising:
a) providing a rank bidding component configured to allow commodity providers to bid tokens such that each matching commodity provider's offer will be presented to the user in an order based on the number of tokens each matching commodity provider bids,
b) wherein a matching offer of the commodity provider having the highest bid will be presented first,
c) wherein a matching offer of the commodity provider having the second highest bid will be presented second,
d) wherein any other commodity providers' offers may be presented to the user in the order of highest bidder to lowest bidder, and
e) providing a presenter component configured to present the matching commodity providers in a specific order based on the number of tokens bid.

12) The method of claim 11, further comprising:
a) if more than one commodity provider bids the same number of maximum tokens per bid, then a random commodity provider is selected for the first rank (N);
b) wherein the commodity providers that are not randomly selected for the Nth rank will be assigned the rank of N+1, N+2, . . . N+G, based on the number of tokens bid, until all of the commodity providers have been ranked.

13) The method of claim 9, further comprising:
a) providing a lead management component, said lead being added to said lead management component;
b) wherein all commodity providers have access to the leads of the lead management component; and
c) wherein each commodity provider may buy the lead for a pre-set number of tokens.

14) The method of claim 13, further comprising:
a) providing a lead bidding component configured to allow commodity providers to bid tokens to acquire a lead;
b) wherein, after a pre-set amount of time, a commodity provider having bid the highest number of tokens will win the lead; and
c) providing a presenter component configured to present the plan of the highest bidding commodity provider to the user for enrollment in the plan.

15) A computer program product for matching commodity providers with commodity users, the product comprising a computer-readable storage device storing computer-executable instructions, which when executed by a computer, perform the following:
a) serve a web page from a web server to a client browser, the web page served to collect a commodity user's offer data and at least one commodity provider's offer data entered via the served web page;
b) collect the commodity user's offer data, wherein the commodity user's offer data is entered via the served web page;
c) collect the commodity provider's offer data, wherein the commodity provider's offer data is entered via the served web page;
d) provide a first mechanism in the served web page that activates when the mechanism detects commodity user offer data that falls within a range of at least one commodity provider's data, said first mechanism containing code necessary to detect an offer match;
e) provide a second mechanism in the served web page that activates when the commodity user offer data does not fall within a range of a retailer commodity provider's offer, said second mechanism containing code necessary to detect when an offer does not match.

16) The computer program product of claim 15, further performing the following:
a) in the case of a match, serve a web page from a web server to the client browser, the web page served to allow the commodity user to purchase the commodity.

17) The computer program product of claim 16, further performing the following:
a) provide a rank bidding component in the served web page configured to allow commodity providers to bid tokens such the each matching commodity provider's offer will be presented to the user in an order based on the number of tokens each matching commodity provider bids,
b) serve a web page from a web server to the client browser, the web page served to display a matching offer of the commodity provider having the highest bid in the first position,
c) serve a web page from a web server to the client browser, the web page served to display a matching offer of the commodity provider having the second highest bid in the second position, and
d) serve a web page from a web server to the client browser, the web page served to display any other commodity providers' offers to the user in the order of highest bidder to lowest bidder.

18) The computer program product of claim 17, further performing the following:
a) if more than one commodity provider bids the same number of maximum tokens per bid, serve a web page from a web server to the client browser, the web page served to display a random commodity provider selected for the first rank (N);
b) serve a web page from a web server to the client browser, the web page served to display said commodity providers not randomly selected for the Nth rank receiving the rank of N+1, N+2, . . . N+G, based on the number of tokens bid, until all of the commodity providers have been ranked.

19) The computer program product of claim 18, further performing the following:
a) provide a charging component configured to charge tokens to at least one of the commodity providers that is displayed to a user;
b) wherein, the number of tokens charged to the at least one commodity provider in the ranking is dependent on the total number of qualifying plans;
c) wherein, the maximum number of final tokens charged to each commodity provider in the ranking is equal or less than the number of matching plans offered to the user.

20) The computer program product of claim 15, further performing the following:
a) in the case of no match, serve a web page from a web server to the client browser, the web page served to allow the commodity user to enter additional billing information, said billing information and the commodity user's offer comprising a lead; and
b) provide said lead to a database accessible to commodity providers.

21) The computer program product of claim 20, further performing the following: each commodity provider may buy the lead for a pre-set number of tokens.

22) The computer program product of claim 20, performing the following:
a) if no commodity providers buy the lead, provide a lead bidding component such that the commodity providers may bid a certain amount of tokens to acquire the lead;
b) wherein, after a preset amount of time, a commodity provider having bid the highest number of tokens will win the lead; and
c) serve a web page from a web server to the client browser, the web page served to display the plan of the highest bidding commodity provider to the user for enrollment in the plan.
